(19) United States
(12) Patent Application Publication
(10) Pub. No.: US 2009/0033460 A1
(43) Pub. Date: Feb. 5, 2009

(54) System and Method for Operating a Transmitter With a Proximity Sensor

(75) Inventors: David Thomas Mack, Scottsdale, AZ (US); Robert Roy Keller, JR., Park Ridge, IL (US); James Joseph Fitzgibbon, Batavia, IL (US)

Correspondence Address: FITCH EVEN TABIN AND FLANNERY, 120 SOUTH LA SALLE STREET, SUITE 1600, CHICAGO, IL, 60603-3406, US

(73) Assignee: THE CHAMBERLAIN GROUP, INC., Elmhurst, IL (US)

(21) Appl. No.: 12/249,131

(22) Filed: Oct. 10, 2008

Related U.S. Application Data
(63) Continuation-in-part of application No. 11/393,424, filed on Mar. 30, 2006.

(51) Int. Cl. B60R 25/00

(52) U.S. Cl. 340/5.71

(57) ABSTRACT

A system and method are provided that use at least one proximity sensor to illuminate a transmitter such that the transmitter can be seen by the user and/or to activate the transmitter so that the user can interface with the transmitter and send code to a receiver via the transmitter to effect an action, such as the opening or closing of a barrier or garage door. The transmitter can also be deactivated so that the proximity sensor is not continually triggering actions by the transmitter thereby potentially causing unwanted actions by the transmitter.

### RELATED APPLICATIONS

This application is a continuation-in-part application of now pending U.S. patent application Ser. No. 11/393,424 filed Mar. 30, 2006 and published as U.S. 2007/0236360 on Oct. 11, 2007. U.S. patent application Ser. No. 11/393,424 is incorporated by reference as if fully rewritten herein.

### TECHNICAL FIELD

This invention relates generally to transmitters and more specifically to transmitters for movable barrier operators having proximity sensors.

### BACKGROUND

Different types of moveable barrier operators have been sold over the years and these systems have been used to actuate various types of moveable barriers. For example, garage door operators have been used to move garage doors, and gate operators have been used to open and close gates. Such barrier movement operators may include a wall control unit, which sends signals to a head unit thereby causing the head unit to open and close the barrier. In addition, these operators often include a receiver unit to receive wireless transmissions from a hand-held code transmitter or from a keypad transmitter, which may be affixed to the outside of the area closed by the barrier or other structure.

Transmitters are used under many different types of environmental conditions. For example, the transmitters may need to be operated when it is dark and it is difficult for a user to see the transmitter. In another example, wet, foggy, or snowy conditions may make it difficult for a user to see the transmitter. Under these adverse conditions, it may be difficult or impossible for the user to activate the transmitter. This may prove to be undesirable or even dangerous in many situations where a quick entry into the area controlled by the barrier entry system is desired or required.

In previous systems, lights at the device may be activated when a button on the device is touched. Unfortunately, it may be difficult or impossible in many situations to initially locate the device or the button. Consequently, the user is still faced with the problem of not finding or activating the device in order to quickly actuate the barrier.

As described in U.S. 2007/0236360, proximity sensors may be used to illuminate and/or to activate the transmitters to send code transmissions, for example to operate a movable barrier operator, in response to activation of a proximity sensor. As described in U.S. 2007/0236360, the proximity sensor is built into the transmitter such that the transmitter performs a command to illuminate the transmitter and/or activate the transmitter to send code transmissions in response to sensing a portion of a user near the proximity sensor.

Although transmitters with proximity sensors add a level of security or ease of use, such transmitters may be taken and carried by a user by hand or in a pocket or purse. In such a situation, the proximity sensor may be continually triggering actions by the transmitter thereby potentially causing unwanted actions by the transmitter and/or garage door operator and reducing battery life for the transmitter.

### SUMMARY

A system and method are provided that use at least one proximity sensor to illuminate a transmitter such that the transmitter can be seen by the user and/or to activate the transmitter so that the user can interface with the transmitter and/or send code to a receiver via the transmitter to effect an action, such as the opening or closing of a barrier or garage door.

In the system and method described herein, the transmitter can also be deactivated so that the proximity sensor is not continually triggering actions by the transmitter thereby potentially causing unwanted actions by the transmitter and/or garage door operator and reducing battery life for the transmitter. The transmitter has a proximity sensing feature that is programmable to enable and disable the proximity sensing feature to allow use or handling of the transmitter without inadvertently triggering actions by the transmitter through the proximity sensing feature. In one approach, the transmitter, such as a transmitter for use with a moveable barrier and its operator, includes at least one proximity sensor which senses a proximity of at least a portion of a user (e.g., the hands of a user), a user interface (such as a key pad) which accepts commands from the user; an illumination device which illuminates at least a portion of the transmitter (such as the keypad), an illumination device activator which activates the illumination device, a transmitter code activator which activates the transmitter to send code, and a controller coupled to the at least one sensor. The controller is coupled to the proximity sensor, the illumination device activator, and the transmitter code activator. In various approaches, the illumination device and illumination device activator may be omitted, or the transmitter code activator may be omitted. The controller is programmed to receive an indication from the proximity sensor that the sensor senses at least a portion of the user. With the sensing of the proximity of the user and communication of that fact to the controller, the controller is programmed to execute an activate command to at least one of the illumination device activator and the transmitter code activator in response to receiving the indication of the proximity of the user from the at least one sensor. So that the illumination device activator and/or the transmitter code activator will not be needlessly and repetitively activated, the transmitter has an activation switch which has an activate position to permit the controller to execute the activate command. The activation switch also has a deactivate position to disable the controller from executing commands to activate the illumination device or to activate the transmitter to send code to the receiver. The switch may be a physical switch which is moved between the activated and deactivated position. Alternatively, the switch may be a software switch.

In another aspect, the controller is disabled from executing commands to the illumination device activator and/or the transmitter code activator upon the occurrence of a disabling event. The disabling event is selected from the group consisting of (i) at least a portion of the user is in proximity to the at least one sensor for more than a set period of time, (ii) when the at least one sensor is within a minimum distance from the portion of the user, (iii) the transmitter is not within a minimum distance from a circuitry activator which effects commands to the moveable barrier operator when the transmitter is within the minimum distance from the circuitry activator, (iv) the at least one sensor senses the at least a portion of the user more than a preset number of times within a preset amount of time, (v) the at least one sensor senses the at least a portion of the user in a position other than a position relative to the transmitter to execute a command to at least one of the illumination device activator and the transmitter code activator, and (vi) a switch which is physically moved from an activate position to a deactivate position to deactivate the sensor.

The proximity sensor may be a capacitance sensor, a radio frequency (RF) energy detector, an infrared energy sensor, or a visible light sensor.

The transmitter may include circuitry configured to sense proximity to the circuitry activator. The circuitry activator is associated with a mounting surface such that the transmitter is in an activatable configuration when the circuitry senses proximity of the circuitry activator when the transmitter is mounted to the mounting surface. In this embodiment, the transmitter is in a non-activatable configuration when the circuitry does not sense proximity of the circuitry activator when the transmitter is not mounted to the mounting surface.

In another aspect, the controller is programmed to activate the illumination activator at a first distance between the portion of the user and the transmitter, and the controller is programmed to activate the transmitter code activator at a second distance between the portion of the user and the transmitter. In this aspect the user activates via the proximity sensor the illumination of the transmitter at the first distance, and the user activates via the proximity sensor the transmitter to send code at the second distance with the first distance being greater than the second distance.

In general the method is operating the transmitters described above. In one aspect in the method for operating and disabling transmitters as described herein, the transmitter comprises at least one sensor configured to sense a proximity of at least a portion of a user, user interface which accepts commands from the user, an illumination device which illuminates at least a portion of the transmitter, a transmitter code activator which activates the transmitter to send code, an illumination device activator, an activation switch, and a controller. The controller is coupled to the at least one sensor, the illumination device activator, the transmitter code activator, and the activation switch. The controller is programmed to receive an indication of the proximity of the at least a portion of the user from the at least one sensor which causes the controller to activate the illumination of the transmitter and/or activate the transmitter to send code. Using such a transmitter, the method includes sensing by the at least one proximity sensor a proximity of the at least a portion of a user to the transmitter, executing an activate command to at least one of the illumination device activator and the transmitter code activator in response to receiving an indication of the proximity of the at least portion of the user from the at least one sensor, and disabling response to receiving an indication of the proximity of the at least portion of the user from the at least one sensor by moving the activation switch from an activated position to a deactivated position.

In another aspect the method includes operating a transmitter which includes at least one sensor which senses a proximity of at least a portion of a user, a user interface which accepts commands from the user, an illumination device which illuminates at least a portion of the transmitter, an illumination device activator which activates the illumination device, a transmitter code activator which activates the transmitter to send code, and a controller. As described above the controller is coupled to the at least one sensor, the illumination device activator, and the transmitter code activator. The controller is programmed to receive an indication of the proximity of the at least a portion of the user from the at least one sensor which causes the controller to activate the illumination of the transmitter and/or activate the transmitter to send code. With this transmitter, the method comprises sensing by the at least one proximity sensor a proximity of the at least a portion of a user to the transmitter, executing an activate command to at least one of an illumination device activator and a transmitter code activator in response to receiving an indication of the proximity of the at least portion of the user from the at least one sensor, and disabling the controller from executing commands to at least one of the illumination device activator and the transmitter code activator upon a disabling event. The disabling event is selected from the group consisting of (i) at least a portion of the user is in proximity to the at least one sensor for more than a set period of time, (ii) when the at least one sensor is within a minimum distance from the portion of the user, (iii) the transmitter is not within a minimum distance from a circuitry activator which effects commands to the moveable barrier operator when the transmitter is within the minimum distance from the circuitry activator, (iv) the at least one sensor senses the at least a portion of the user more than a preset number of times within a preset amount of time, (v) the at least one sensor senses the at least a portion of the user in a position other than a position relative to the transmitter to execute a command to at least one of the illumination device activator and the transmitter code activator, and (vi) a switch which is physically moved from an activate position to a deactivate position to deactivate the sensor.

### DESCRIPTION OF THE DRAWINGS

FIG. 1 comprises an example system of a transmitter and movable barrier operator in accordance with various embodiments of the invention;

FIG. 2 comprises a block diagram of an example transmitter as configured in accordance with various embodiments of the invention;

FIG. 3 comprises a block diagram of an example system with a transmitter sensing a plurality of zones as configured in accordance with various embodiments of the invention;

FIG. 4 comprises a diagram of an example transmitter having a plurality of sensors as configured in accordance with various embodiments of the invention.

FIG. 5 comprises a perspective view of an example transmitter with a switch disposed in the transmitter housing as configured in accordance with various embodiments of the invention;

FIG. 6 comprises a perspective view of an example transmitter with a switch disposed in the transmitter housing with a mounting portion and a mounting surface as configured in accordance with various embodiments of the invention;

FIG. 7 comprises a side view of an example transmitter with a push-button type switch engaging an example mounting surface as configured in accordance with various embodiments of the invention;

FIG. 8 comprises a side view of an example transmitter with a push-button type switch not engaging an example mounting surface as configured in accordance with various embodiments of the invention;

FIG. 9 comprises a side view of an example transmitter with a two-position switch engaging an example mounting surface as configured in accordance with various embodiments of the invention;

FIG. 10 comprises a side view of an example transmitter with a two-position switch not engaging an example mounting surface as configured in accordance with various embodiments of the invention;

FIG. 11 comprises a side view of an example transmitter with a circuit activator sensor engaging an example mounting surface as configured in accordance with various embodiments of the invention;

FIG. 12 comprises a side view of an example transmitter with a circuit activator sensor not engaging an example mounting surface as configured in accordance with various embodiments of the invention; and

FIG. 13 comprises a flow diagram of an example method of operating a transmitter as configured in accordance with various embodiments of the invention.

### DETAILED DESCRIPTION

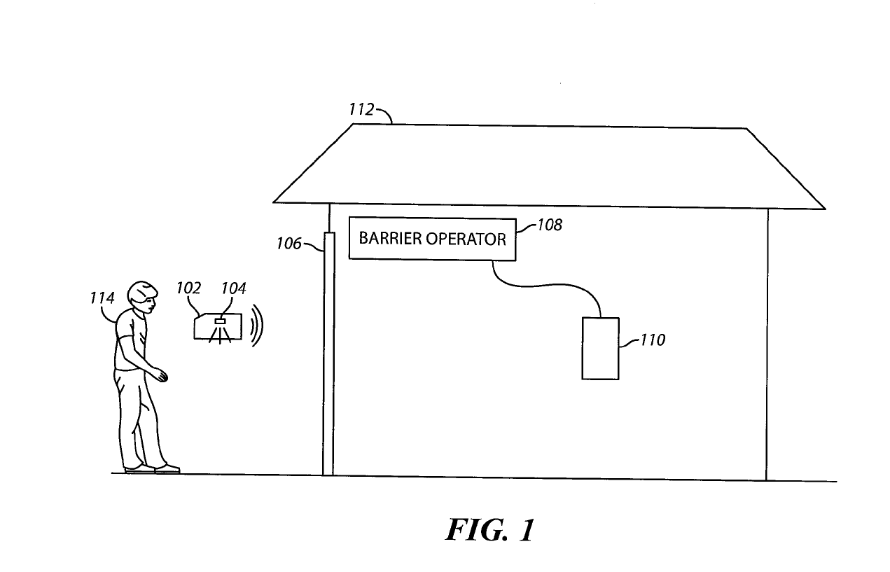

Referring now to the drawings, and in particular to FIG. 1, one example of a system for controlling, activating, and deactivating a transmitter with a proximity sensor is described. A transmitter 102 is used by a user 114 to actuate a barrier operator 108 in a moveable barrier operator system. The operator 108 moves a barrier 106. In addition, a wall control unit 110 may also allow the user 114 to open and close the barrier 106, program the operator 108, or perform other functions. The operator 108 is housed in a garage 112. The transmitter 102 includes an indicator 104 that may illuminate the transmitter 102 when the transmitter 102 senses the proximity of the user 114.

The transmitter 102 may include one or more functions to actuate the barrier operator 108 and may be positioned in various locations to aid in actuating the barrier operator 108. For example, the transmitter 102 may be carried in a vehicle of the user 114. In another approach, the transmitter 102 may be attached to the garage 112. Other locations can also be used when positioning the transmitter 102. The transmitter 102 may send codes that actuate various barrier functions such as opening the barrier, closing the barrier, actuating a light, or actuating a security system. The transmitter 102 may also have a learn mode where it learns the various codes.

The system of FIG. 1 is depicted as having a barrier operator 108 that is a garage door operator 108 and a barrier 106 that is a garage door. It will be understood, however, that many different types of barrier operators and barriers may be used. For example, the barrier operator 108 may be a gate operator and a sliding door operator. In another example, the barrier 106 may be a front door, sliding gate, swinging gate, or shutters. Other examples of barriers and barrier operators are possible.

In one example of the operation of the system of FIG. 1, a proximity sensor or sensors at the transmitter 102 senses the proximity of a portion of a user to the transmitter 102. For example, the presence of a user's hand may be detected. In another example, the presence of the arm of the user is detected. The detection of the presence of the user or a portion of the user may be accomplished by any suitable sensing arrangement such as a capacitive sensor, passive or active infrared sensor, light sensor, RF sensor, or a sonic sensor. Other sensors may also be used.

Subsequent to the detection of the presence of the user 114, the indicator 104 (e.g., the illumination device) may be actuated to illuminate a portion of the code transmitter 102. The illumination facilitates the visibility of at least one transmitter function to the user. For example, light emitting diodes may be embedded in the transmitter, and control buttons on the transmitter may be illuminated. Consequently, if the user 114 is in a dark location or otherwise undesirable environmental conditions exist that interfere with viewing of the transmitter 102, the transmitter 102 becomes illuminated making it easy for the user 114 to utilize the functions of the transmitter 102.

In addition to, or instead of illuminating the transmitter 102, the transmitter 102 may be actuated to send a code to actuate the operator 108 in response to detection of the presence of the user. The transmitter 102 may learn the code to send upon sensing the proximity of the portion of the user 114.

In other examples, an activation location associated with the portion of the user 114 may be determined. The transmitter action may be determined and based upon the activation location. In this regard, different codes may be sent or actions taken by the transmitter 102 depending upon where the presence of the user 114 was detected. For example, different codes may be sent depending upon whether the user 114 was detected directly in front of, to the right, or to the left of the transmitter 102.

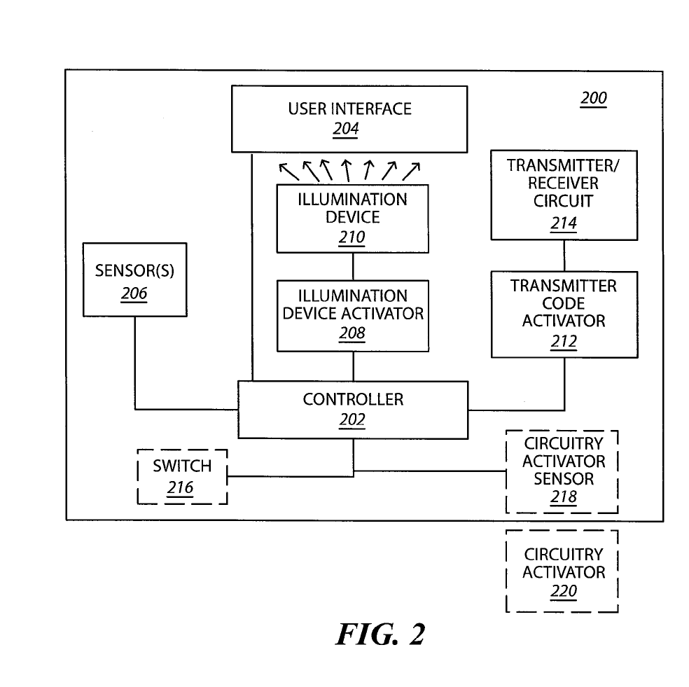

Referring now to FIG. 2, one example of a transmitter 200 is described. The transmitter 200 includes a user interface 204 that accepts commands from the user, at least one sensor 206 that senses a proximity of at least a portion of a user, an illumination device activator 208 which activates an illumination device 210 (the illumination device 210 when activated illuminates at least a portion of the transmitter 200), a transmitter code activator 212 which activates the transmitter 200 via a transmitter/receiver circuit 214 to send code. A controller 210 is coupled to the at least one sensor 206, the illumination device activator 208 and/or the transmitter code activator 212, and, optionally, a switch 216 and/or a circuitry activator sensor 218. As described herein, the circuitry activator sensor 218 interacts with a circuitry activator 220 to bring about the ability of the controller 202 to send commands to the illumination device activator 208 and/or the transmitter code activator 212. Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

The sensor 206 senses the proximity of a portion of a user to the transmitter 200. In this regard, the sensor 206 may be a capacitance sensor, a radio frequency (RF) energy detector, a passive or active infrared energy sensor, or a visible light sensor. Other examples of sensors are possible. In addition, more than one sensor may be used. In one specific example, and as mentioned, the sensor 206 may be a capacitance sensor. In this case, the sensor may detect changes in capacitance as objects come into proximity of the sensor 206. The change in capacitance may be compared to the threshold, and when the change exceeds the threshold, it may be determined that an object is in proximity to the sensor 206.

The user interface 204 accepts commands from the user. In this regard, the user interface 204 may comprise one or more buttons, a keypad, a touch screen, or any other device or actuator allowing the user to enter input data into the system to actuate functions of the system. Example functions that may be actuated through use of the user interface include opening a barrier, closing a barrier, actuating a light, and actuating a security system. One or more illumination devices 208 are positioned to illuminate at least a portion of the user interface 204. For example, the illumination devices 208 may be lights or light emitting diodes.

The transmitter/receiver circuit 214 transmits a signal to an external device (e.g., barrier operator, television, stereo, or computer) to actuate the external device. The transmitter/receiver circuit 214 may transmit a code to the operator and the code may be learned by the transmitter/receiver circuit 214. The transmitter/receiver circuit 214 may also receive transmissions from external devices.

The controller 210 is programmed to execute an activate command to at least one of the illumination device activator 208 and the transmitter code activator 212 in response to receiving an indication of the proximity of the at least a portion of the user from the at least one sensor 206. Such commands may include responsively activating an illumination device 210 to illuminate at least a portion of the user interface 204 and/or actuating the transmitter 200 to send a code to a barrier operator 108, for example, to move a barrier 106 or actuate a light. For example, an LED may be activated to illuminate a transmit button on the user interface 204. In other examples, the controller 202 is programmed to, subsequent to or in combination with actuating the at least one illumination device 210, actuate the transmitter 200 to transmit a code. The controller 202 may also be programmed to learn a code upon sensing the proximity of the user.

In other examples, the controller 202 is programmed to activate the illumination device activator 208 in response to receiving an indication that the proximity of the at least a portion of the user is at a first distance from the at least one sensor 206, and the controller 202 is programmed to activate the transmitter code activator 212 in response to receiving an indication that the proximity of the at least a portion of the user is at a second distance from the at least one sensor 206, the first distance being greater than the second distance. In other examples, the controller 202 is programmed to determine an activation location associated with the portion of the user. A code or action may also be determined based upon the activation location. In still other examples, multiple sensors may be used to detect multiple proximities and activate selected illumination devices. In this case, the illumination device closest to the portion of the user may be illuminated.

In some approaches, the user interface 204 is not needed such as in the case where the transmitter 200 sends code in response to an indication of proximity sensed by the sensor 206. In one such example, the illumination device activator 208 and the illumination device 210 are also omitted because the user interface 204, when not included, does not need illumination. One such application would include a wireless transmitter configured to send code via, for example, a radio frequency transmission to operate a garage door system in response to sensing a user's hand. In this example, the controller 202 is coupled to the transmitter code activator 212 and executes commands to the transmitter code activator 212 in response to receiving an indication of the proximity of a portion of a user from the sensor 206. By one approach, the controller 202 is coupled to an activation switch 216 such that the controller 202 executes commands to the transmitter code activator 212 when the activation switch 216 is in a first configuration; the controller 202 in such an approach is disable from execution of commands to the transmitter code activator 212 when the activation switch 216 is in a second configuration. By another approach, the controller 202 is disabled from executing commands to the transmitter code activator 212 in response to a disabling event as discussed herein.

In accordance with the various approaches described herein, in response to a disabling event, the controller 202 is disabled from executing commands to at least one of the illumination device activator 208 and the transmitter code activator 212. The disabling event may be one or more of many triggers to stop the transmitter 200 from executing commands through inadvertent receipts of indications of proximity via the sensor 206. The disabling of operation in response to the proximity sensor 206 may be accomplished by disabling the proximity sensor(s) 206 or, in software in the controller 202, ignoring receipt of indications of proximity of a portion of a user from the sensor 206. The controller 202 may be programmed to re-enable execution of commands by various means such as through a particular activation of the sensor 206 or through other means such as by actuation of a reset switch 214 or other method.

One example disabling event includes disabling the execution of commands in response to receiving an indication that at least a portion of the user is in proximity to the at least one sensor 206 for more than a set period of time. In this approach, the controller 202 is programmed to determine a time period during which the proximity of the portion of the user was sensed. The controller 210 is programmed to execute a command in response to determining that the time period has a first relationship with a time period limit and, in response to determining that the time period has a second relationship to the time period limit, to disable execution of commands in response to receiving the indication of the proximity of the portion of the user from the at least one sensor. In this example, the user may disable operation of the transmitter 200 in response to the proximity sensor 206 by, for example, holding a hand in front of the sensor 206 for more than an arbitrary time limit such as approximately four seconds. The controller 202 may be programmed to re-enable execution of commands by activation of the sensor 206 for a particular time period, such as approximately four seconds, or through other means such as by actuation of a reset switch or other method.

Another option includes stopping execution of commands when the at least one sensor 206 is within a minimum distance from the portion of the user. Here, when the sensor 206 is configured to sense distance, for example by having multiple sensors, each capable of sensing proximity at different distances, the controller 202 can disable execution of commands upon receiving an indication of proximity at a particular distance.

Still another example disabling event includes where the at least one sensor 206 senses the at least a portion of the user more than a preset number of times within a preset amount of time. Here, the controller 202 is programmed to count the number of received indications of proximity from the sensor 206 over a particular time period. Should the controller 202 determine that the number of indications exceeds a particular number, such as three, over a time period, such as five seconds, the controller 202 will disable execution of commands to the illumination device activator 208 and/or the transmitter code activator 212 in response to receipt of indications of proximity.

Yet another example disabling event includes where the at least one sensor 206 senses the at least a portion of the user in a position other than a position relative to the transmitter 200 to execute a command to at least one of the illumination device activator 208 and the transmitter code activator 212. In this example, the controller 202 is programmed to disable execution of commands in response to receiving the indication of the proximity of the portion of the user from the at least one sensor 206 by determining an activation location associated with the portion of the user that is in a certain location such as a preset zone relative to the transmitter. For example, the sensor 206 may include three sensors disposed to sense the proximity of a portion of the user in different spaces or zones relative to the transmitter 200 such that the user may wave a hand in a space to the left or right of the transmitter 200 relative to the sensors whereby upon receiving an indication of the proximity of the user in the certain location or preset zone relative to the transmitter, the controller 210 will take an action such as execute a command to the illumination device activator 208 and/or the transmitter code activator 212 or disable execution of commands in response to the receipt of indications of proximity in certain zones or positions from the sensor 206. Thus, the user can turn off the operation of commands in response to the proximity sensor 206 by activating the sensor in a particular zone or location. The controller 210 may be programmed to enable execution of commands by activation of the sensor 206 in the particular zone or location or through other means such as by actuation of a reset switch 214 or other method.

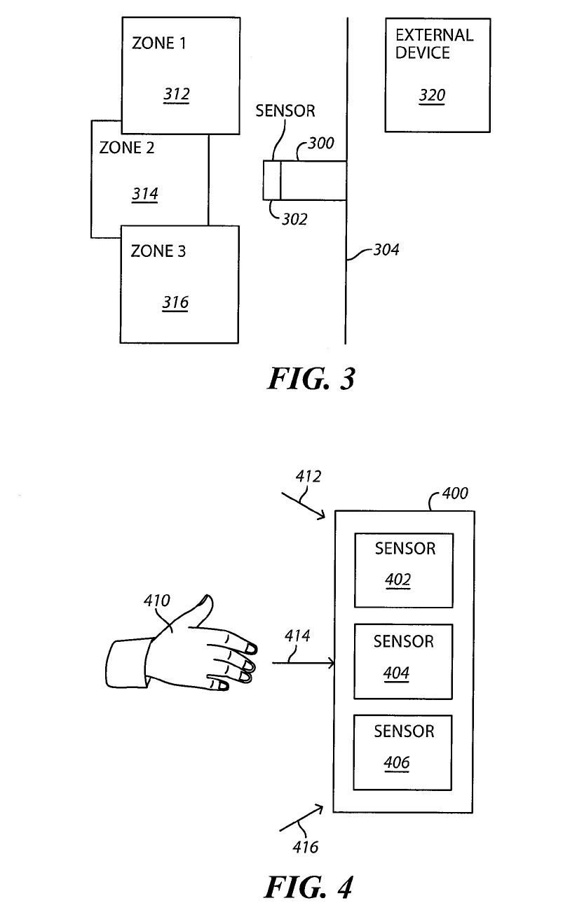

With reference now to FIG. 3, one example of a system for sensing different positions or locations of a portion of a user is described. A transmitter 300 having a sensor 302 is mounted to a mounting surface 304. Zones 312, 314, and 316 are positioned about the transmitter 300. The transmitter 300 is programmed to operate differently depending upon the zone where the presence of the user is detected. For example, the user can disable the execution of commands or send different codes to an external device 320 (e.g., barrier operator, television, stereo, or computer) depending upon the zone where the presence of the user is detected.

Referring now to FIG. 4, another example of a transmitter that senses the activity location of a proximity of a user is described. A transmitter 400 includes sensors 402, 404, and 406. The sensors 402, 404, and 406 are positioned such that they can detect the proximity (or approach) of a portion of a user from any direction (e.g., above, below, under, to the left, to the right, or from any other direction). Consequently, the sensors 402, 404, and 406 can be positioned at various locations at the transmitter 400 depending upon the layout and dimensions of the transmitter 400, the type of sensor, and the directions for which proximity detection is required. In addition, although three sensors are shown in FIG. 4, it will be understood that any number of sensors can be used.

A hand 410 of a user may approach the transmitter 400 from directions 412, 414, and 416. In this example, the sensors are positioned such that the sensor 402 will detect the hand 410 if it approaches from direction 412. Furthermore, the sensor 404 will detect the hand if it approaches from direction 414. Finally, the sensor 416 will detect the proximity of the hand if it approaches from direction 416.

Referring again to FIG. 2, another example disabling event includes where a switch 216 which is physically moved from an activate position to a deactivate position to deactivate the sensor 206. The switch 216 can be an activation switch that controls the ability to execute commands in response to sensing proximity of a portion of a user. By one such approach, the controller 202 is coupled to the at least one sensor 206, the illumination device activator 208, the transmitter code activator 212, and an activation switch 216. The controller 202 is programmed to receive an indication of the proximity of the at least a portion of the user from the at least one sensor and to execute a command in response to receiving an indication of the proximity of the portion of the user from the at least one sensor 206 when the switch 216 is in a first configuration. The controller 202 in this approach is programmed to disable execution of commands to at least one of the illumination device activator 208 and/or the transmitter code activator 212 in response to receiving the indication of the proximity of the portion of the user from the at least one sensor 206 when the switch 216 is configured in a second configuration. The activation switch 216 can comprise at least one switch selected from the group consisting of a software switch and a switch which is physically moved from an activate position to a deactivate position to disable execution of commands. The physical switch 216 may be a dual state switch, a press and hold button switch, or other switch able to operate in a least two configurations. The software switch may be programming at the controller 202 configured to disable execution of commands when triggered to be in the second, non-activatable configuration.

So configured, the disabling event stops the transmitter 200 from executing commands and wasting battery life through inadvertent receipts of indications of proximity via the sensor 206. The transmitter may be configured to respond to any one or more the disabling events discussed herein to suit a particular application. Those skilled in the art will recognize and appreciate that such a controller as described herein can comprise a fixed-purpose hard-wired platform or can comprise a partially or wholly programmable platform. All of these architectural options are well known and understood in the art and require no further description here.

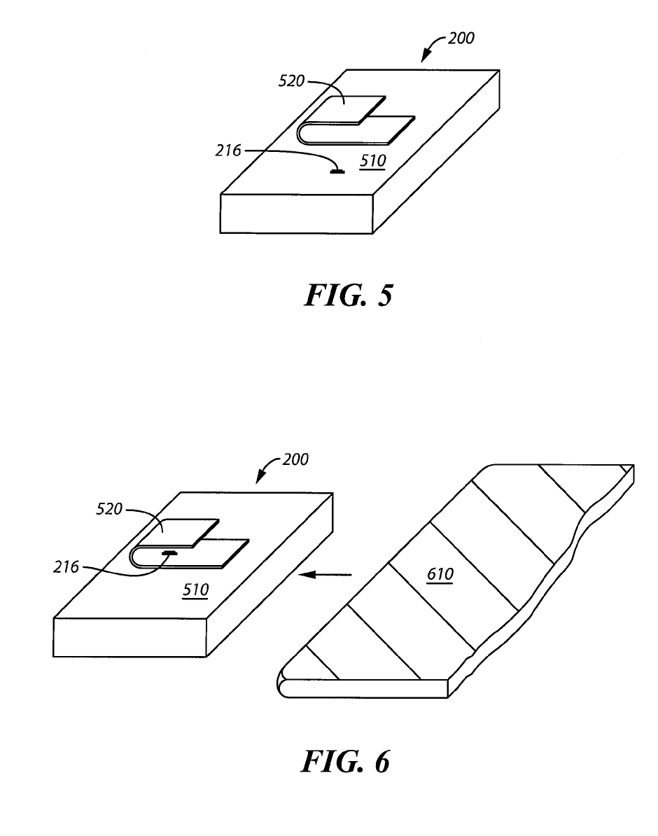

With reference to FIGS. 5-12, the switch 216 may be implemented in the transmitter in a variety of ways. FIGS. 5 and 6 illustrate two example approaches where a switch 216 is disposed in a housing 510 for the transmitter 200. The switch 216 may be a dual state switch such that the user may toggle the switch 216 to enable and disable execution of commands in response to receiving indications of proximity from the proximity sensor 206. The configuration of FIG. 5 may also be used where the switch 216 is a press and hold switch used as a reset switch such that the controller 202 re-enables execution of commands in response to receipt of indications of proximity from the proximity sensor 206 as described above.

With reference to the example of FIG. 6, the housing 510 is configured to engage a mounting surface 610. The activation switch 216 is configured to be physically engaged to enable or disable execution of commands, and the transmitter 200 includes a housing 510 configured to engage the mounting surface 610 wherein the activation switch 216 is disposed relative to a housing portion 520 engaging the mounting surface 610 when the transmitter 200 is mounted to the mounting surface 610. So configured, the switch 216 is disposed in the housing portion 520 to be actuated by the mounting surface 610 when the transmitter 200 is mounted to or removed from the mounting surface 610. The mounting surface 610 can be any structure suitable for mounting the transmitter 200 such as a visor in a vehicle, a mounting bracket on a wall of a garage, or other structure. The switch 216 need not be disposed in the clip as shown, but may be placed elsewhere on the housing 510 to be actuated by the mounting surface 610.

For example, in FIGS. 7 and 8, the switch 216 is a press and hold switch 716 such that when the transmitter 200 is mounted on the mounting surface 610 as in FIG. 7, the press and hold switch 716 is held in a first, pressed configuration, and when the transmitter 200 is not mounted on the mounting surface 610 as in FIG. 8, the press and hold switch 716 is in a second, released configuration. So configured, the controller 202 is programmed to execute commands when the transmitter 200 is mounted on the mounting surface 610 because the press and hold switch 716 is held in the first configuration by the mounting surface 610, and the controller 202 is programmed to disable execution of commands when the transmitter 200 is removed from the mounting surface 610 so as to automatically reduce the possibility of execution of commands accidentally through activation of the proximity sensor 206 when a user is handling the transmitter 200.

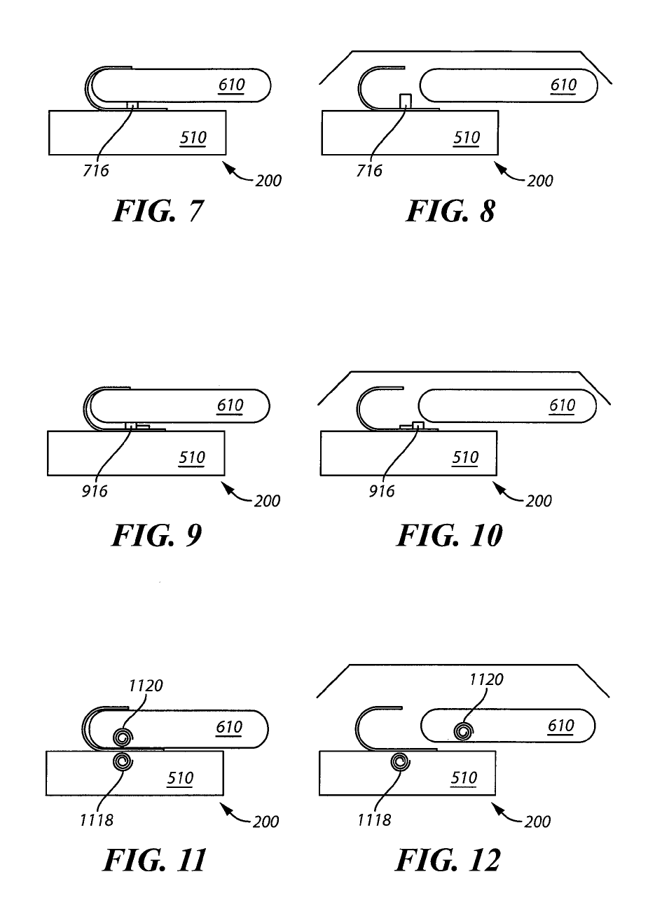

In another approach illustrated in FIGS. 9 and 10, the switch 216 is a dual state switch 916 such that when the transmitter 200 is mounted on the mounting surface 610 as in FIG. 9, the dual switch 916 is pushed into a first configuration through friction with the mounting surface 610, and when the transmitter 200 is removed from the mounting surface 610 as in FIG. 10, the dual state switch 916 is pulled into a second configuration via friction with the mounting surface 610. So configured, the controller 202 is programmed to execute commands when the transmitter 200 is mounted on the mounting surface 610 because the dual state switch 916 is forced into the first configuration by the mounting surface 610, and the controller 202 is programmed to disable execution of commands when the transmitter 200 is removed from the mounting surface 610 so as to automatically reduce the possibility of execution of commands accidentally through activation of the proximity sensor 206 when a user is handling the transmitter 200.

By still another approach, referring again to FIG. 2, the disabling event can include where the transmitter 200 is not within a minimum distance from a circuitry activator 220 which effects commands to the moveable barrier operator 108 when the transmitter 200 is within the minimum distance from the circuitry activator 220. In this approach, the transmitter 200 includes a circuitry activator sensor 218 configured to sense proximity to the circuitry activator 220. As illustrated in the example of FIGS. 11 and 12, the circuitry activator 1120 is associated with the mounting surface 610 such that the transmitter 200 is in an activatable configuration when the circuitry activator sensor 1118 senses proximity of the circuitry activator 1120 when the transmitter 200 is mounted to the mounting surface 610. The transmitter 200 is in a non-activatable configuration when the circuitry activator sensor 1118 does not sense proximity of the circuitry activator 1120 when the transmitter 200 is not mounted to the mounting surface 610.

The circuitry activator sensor 1118 is configured to sense proximity of a circuitry activator 1120. The controller 202 is programmed to allow execution of commands when the circuitry activator sensor 1118 senses proximity of the circuitry activator 1120, and the controller 202 is programmed to not allow execution of commands when the circuitry activator sensor 1118 does not sense proximity of the circuitry activator 1120. Such a sensor 1118 that responds to proximity of an actuating presence is known. For example, a coil of wire connected to a sensing circuit will generate a current when a magnetic field is passed by the coil of wire. In this case, the controller 202 connected to the coil of wire will sense the current generated when the circuitry activator 1120 is a magnet that is passed next to the coil. Another example includes where the circuitry activator sensor 1118 comprises a coil of wire that passively inductively couples to another coil acting as the circuitry activator 1120, whereby the inductive coupling creates a current sensed by the controller 202 to determine whether the circuitry activator 1120 is near the circuitry activator sensor 1118. Such embodiments allow the controller 202 to change between a first configuration and a second configuration based upon the relative placement of the circuitry activator sensor 1118 and the circuitry activator 1120.

More specifically, in the example of FIGS. 11 and 12, the circuitry activator sensor 1118 is configured to sense proximity to a circuitry activator 1120 associated with the mounting surface 610 such that the controller 202 allows execution of commands when the circuitry activator sensor 1118 senses proximity of the circuitry activator 1120 when the transmitter 200 is mounted to the mounting surface 610 as illustrated in FIG. 11. The controller 202 disables execution of commands when the circuitry activator sensor 1118 does not sense proximity of the circuitry activator 1120 when the transmitter 200 is not mounted to the mounting surface 610 as illustrated in FIG. 12. The circuitry activator 1120 is typically mounted within the mounting surface 610 to electrically or magnetically communicate with the circuitry activator sensor 1118 when the transmitter 200 is mounted.

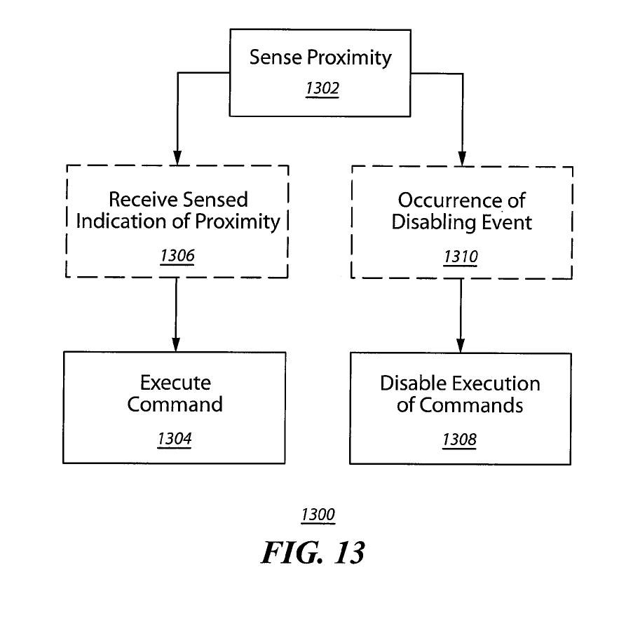

Referring now to FIG. 13, one example of a method 1300 of operating and disabling a transmitter is described. At step 1302, at least one sensor 206 senses a proximity of at least a portion of a user. At step 1304, the transmitter 200 executes an activate command to at least one of an illumination device activator 208 and a transmitter code activator 212. Executing a command may include activating an illumination device 210 and/or actuating the transmitter 200 to send a code. The execution step 1304 is typically performed in response to the controller's 202 receiving at step 1306 an indication of the proximity of the at least a portion of the user from the at least one sensor 206. This indication of proximity may be in the form of a signal from a sensor sensing capacitance, detecting radio frequency (RF) energy, sensing infrared energy, sensing visible light, and/or sensing an activation location associated with the portion of the user. At step 1308, the controller 202 is disabled from executing commands to at least one of the illumination device activator 208 and/or the transmitter code activator 212. The disabling step 1308 is typically performed in response to the occurrence of a disabling event at step 1310 as described herein.

The step of disabling execution of commands may be performed in a number of ways. By way of example, the controller 202 may be programmed to receive sensed indications of proximity and determine the switch 216 position, thereby deferring to the switch 216 position to determine how to react. If the switch 216 is in the second position, execution of commands remains disabled. If the switch 216 is in the first position on receipt of the sensed indication of proximity, the controller 202 will enable command executions and execute a command. In another approach, if the switch 216 is in the second configuration, the proximity sensors 206 may be totally disabled to conserve energy or battery life.

By still another approach, the step 1304 may be performed by executing an activate command to at least one of the illumination device activator 208 and the transmitter code activator 212 in response to receiving an indication of the proximity of the at least portion of the user from the at least one sensor 206. In this approach, the step 1308 is performed by disabling the response to receiving an indication of the proximity of the at least portion of the user from the at least one sensor 206 by moving the activation switch 216 from an activated position to a deactivated position.

Those skilled in the art will appreciate that the above-described processes are readily enabled using any of a wide variety of available and/or readily configured platforms, including partially or wholly programmable platforms as are known in the art or dedicated purpose platforms as may be desired for some applications.

Thus, approaches are provided that allow for a transmitter to disable execution of commands in response to activation of a proximity sensor. In so doing, transmitter functions can be controlled during handling of a transmitter when accidental actuations of the proximity sensor are more likely. Advantageously, the user can then carry a transmitter with a proximity sensor with reduced likelihood of accidentally triggering actions for the transmitter and potentially saving battery life.

Those skilled in the art will recognize that a wide variety of modifications, alterations, and combinations can be made with respect to the above described embodiments without departing from the scope of the invention. For instance, the various methods of enabling or disabling execution of commands described herein can be mixed and matched such that one method may be applied to disable command execution and another method may be used to enable command execution. Such modifications, alterations, and combinations are to be viewed as being within the ambit of the inventive concept.

What is claimed is:

1. A transmitter for use with a moveable barrier system comprising:
at least one sensor which senses a proximity of at least a portion of a user;
an illumination device which illuminates at least a portion of the transmitter;
an illumination device activator which activates the illumination device;
a transmitter code activator which activates the transmitter to send code;
a controller coupled to the at least one sensor, the illumination device activator, and the transmitter code activator, the controller programmed to receive an indication of the proximity of the at least a portion of the user from the at least one sensor;
wherein the controller is programmed to execute an activate command to at least one of the illumination device activator and the transmitter code activator in response to receiving an indication of the proximity of the at least a portion of the user from the at least one sensor; and
wherein in response to a disabling event, the controller is disabled from executing commands to at least one of the illumination device activator and the transmitter code activator wherein the disabling event is selected from the group consisting of (i) at least a portion of the user is in proximity to the at least one sensor for more than a set period of time, (ii) when the at least one sensor is within a minimum distance from the portion of the user, (iii) the transmitter is not within a minimum distance from a circuitry activator which effects commands to the moveable barrier operator when the transmitter is within the minimum distance from the circuitry activator, (iv) the at least one sensor senses the at least a portion of the user more than a preset number of times within a preset amount of time, (v) the at least one sensor senses the at least a portion of the user in a position other than a position relative to the transmitter to execute a command to at least one of the illumination device activator and the transmitter code activator, and (vi) a switch which is physically moved from an activate position to a deactivate position to deactivate the sensor.

2. The transmitter of claim 1 wherein the at least one sensor comprises at least one of the group consisting of:
a capacitance sensor;
a radio frequency (RF) energy detector;
an infrared energy sensor; and
a visible light sensor.

3. The transmitter of claim 1 wherein the transmitter comprises a circuitry activator sensor configured to sense proximity to the circuitry activator which circuitry activator is associated with a mounting surface such that the transmitter is in an activatable configuration when the circuitry activator sensor senses proximity of the circuitry activator when the transmitter is mounted to the mounting surface and the transmitter is in a non-activatable configuration when the circuitry activator sensor does not sense proximity of the circuitry activator when the transmitter is not mounted to the mounting surface.

4. A transmitter for use with a moveable barrier system comprising:
at least one sensor configured to sense a proximity of at least a portion of a user;
an illumination device which illuminates at least a portion of the transmitter;
a transmitter code activator which activates the transmitter to send code;
an illumination device activator;
an activation switch;
a controller coupled to the at least one sensor, the illumination device activator, the transmitter code activator, and the activator switch, the controller programmed to receive an indication of the proximity of the at least a portion of the user from the at least one sensor;
wherein the controller is programmed to execute a command to at least one of the illumination device activator and the transmitter code activator in response to receiving an indication of the proximity of the at least a portion of the user from the at least one sensor when the activation switch is configured in a first configuration; and
wherein when the activation switch is configured in a second configuration, the controller is programmed to disable execution of commands to at least one of the illumination device activator and the transmitter code activator in response to receiving an indication of the proximity of the portion of the user from the at least one sensor.

5. The transmitter of claim 4 wherein the activation switch comprises at least one switch selected from the group consisting of a software switch and a switch which is physically moved from an activate position to a deactivate position to disable execution of commands.

6. The transmitter of claim 4 wherein the activation switch is configured to be physically engaged to enable or disable execution of commands, the transmitter further comprising a housing configured to engage a mounting surface wherein the activation switch is disposed relative to a housing portion engaging the mounting surface when the transmitter is mounted to the mounting surface.

7. The transmitter of claim 6 wherein the activation switch is disposed in the housing portion to be actuated by the mounting surface when the transmitter is mounted to or removed from the mounting surface.

8. The transmitter of claim 4 wherein the at least one sensor is selected from the group consisting of:
a capacitance sensor;
a radio frequency (RF) energy detector;
an infrared energy sensor; and
a visible light sensor.

9. The transmitter of claim 1 further comprising a user interface which accepts commands from the user.

10. A transmitter for use with a moveable barrier system comprising:
at least one sensor configured to sense a proximity of at least a portion of a user;
an illumination device which illuminates at least a portion of the transmitter;
a transmitter code activator which activates the transmitter to send code;
an illumination device activator;
an activation switch;
a controller coupled to the at least one sensor, the illumination device activator, the transmitter code activator, and the activation switch, the controller programmed to receive an indication of the proximity of the at least a portion of the user from the at least one sensor;
wherein in response to receiving an indication of the proximity of the at least a portion of the user from the at least one sensor when the activation switch is configured in a first configuration, the controller is programmed to execute at least one of a command to the illumination device activator to activate the illumination device and illuminate at least a portion of the transmitter and a command to the transmitter code activator to permit the transmitter to send a code; and
wherein when the activation switch is configured in a second configuration, the controller is programmed to disable execution of commands to at least one of the illumination device and the transmitter code activator in response to receiving an indication of the proximity of the portion of the user from the at least one sensor.

11. The transmitter of claim 10 wherein the activation switch comprises at least one switch selected from the group consisting of a software switch and a switch which is physically engaged to disable execution of commands.

12. The transmitter of claim 10 wherein the activation switch is configured to be physically engaged to enable or disable execution of commands, the transmitter further comprising a housing configured to engage a mounting surface wherein the activation switch is disposed relative to a housing portion engaging the mounting surface when the transmitter is mounted to the mounting surface.

13. The transmitter of claim 12 wherein the activation switch is disposed in the housing portion to be actuated by the mounting surface when the transmitter is mounted to or removed from the mounting surface.

14. The transmitter of claim 12 wherein the controller is programmed to activate the illumination device activator in response to receiving an indication that the proximity of the at least a portion of the user is at a first distance from the at least one sensor and the controller is programmed to activate the transmitter code activator in response to receiving an indication that the proximity of the at least a portion of the user is at a second distance from the at least one sensor, the first distance being greater than the second distance.

15. The transmitter of claim 10 wherein the at least one sensor is selected from the group consisting of:
a capacitance sensor;
a radio frequency (RF) energy detector;
an infrared energy sensor; and
a visible light sensor.

16. The transmitter of claim 10 further comprising a user interface which accepts commands from the user.

17. A method for operating and disabling a transmitter comprising:
at least one sensor which senses a proximity of at least a portion of a user;
an illumination device which illuminates at least a portion of the transmitter;
an illumination device activator which activates the illumination device;
a transmitter code activator which activates the transmitter to send code;
a controller coupled to the at least one sensor, the illumination device activator, and the transmitter code activator, the controller programmed to receive an indication of the proximity of the at least a portion of the user from the at least one sensor;
the method comprising:
sensing by the at least one sensor a proximity of the at least a portion of a user to the transmitter;
executing an activate command to at least one of an illumination device activator and a transmitter code activator in response to receiving an indication of the proximity of the at least a portion of the user from the at least one sensor; and
wherein in response to a disabling event, the controller is disabled from executing commands to at least one of the illumination device activator and the transmitter code activator wherein the disabling event is selected from the group consisting of (i) at least a portion of the user is in proximity to the at least one sensor for more than a set period of time, (ii) when the at least one sensor is within a minimum distance from the portion of the user, (iii) the transmitter is not within a minimum distance from a circuitry activator which effects commands to the moveable barrier operator when the transmitter is within the minimum distance from the circuitry activator, (iv) the at least one sensor senses the at least a portion of the user more than a preset number of times within a preset amount of time, (v) the at least one sensor senses the at least a portion of the user in a position other than a position relative to the transmitter to execute a command to at least one of the illumination device activator and the transmitter code activator, and (vi) a switch which is physically moved from an activate position to a deactivate position to deactivate the sensor.

18. The method of claim 17 wherein the at least one sensor is selected from the group consisting of:
a capacitance sensor;
a radio frequency (RF) energy detector;
an infrared energy sensor; and
a visible light sensor.

19. The method of claim 17 wherein the transmitter comprises a circuitry activator sensor configured to sense proximity to the circuitry activator which circuitry activator is associated with a mounting surface such that the transmitter is in an activatable configuration when the circuitry activator sensor senses proximity of the circuitry activator when the transmitter is mounted to the mounting surface and the transmitter is in a non-activatable configuration when the circuitry activator sensor does not sense proximity of the circuitry activator when the transmitter is not mounted to the mounting surface.

20. A method for operating and disabling a transmitter comprising:
a transmitter comprising:
at least one sensor configured to sense a proximity of at least a portion of a user;
an illumination device which illuminates at least a portion of the transmitter;
a transmitter code activator which activates the transmitter to send code;
an illumination device activator;
an activation switch;
a controller coupled to the at least one sensor, the illumination device activator, the transmitter code activator, and the activation switch, the controller programmed to receive an indication of the proximity of the at least a portion of the user from the at least one sensor;
the method comprising:
sensing by the at least one proximity sensor a proximity of the at least a portion of a user to the transmitter;
executing an activate command to at least one of the illumination device activator and the transmitter code activator in response to receiving an indication of the proximity of the at least portion of the user from the at least one sensor; and
disabling the response to receiving an indication of the proximity of the at least portion of the user from the at least one sensor by moving the activation switch from an activated position to a deactivated position.

21. The method of claim 20 wherein the activation switch comprises at least one switch selected from the group consisting of a software switch and a switch which is physically moved from an activate position to a deactivate position to disable execution of commands.

22. The method of claim 20 wherein the activation switch is configured to be physically engaged to enable or disable execution of commands, the transmitter further comprising a housing configured to engage a mounting surface wherein the activation switch is disposed relative to a housing portion engaging the mounting surface when the transmitter is mounted to the mounting surface.

23. The method of claim 22 wherein the activation switch is disposed in the housing portion to be actuated by the mounting surface when the transmitter is mounted to or removed from the mounting surface.

24. The method of claim 22 wherein the activation switch is disposed in the housing portion to be actuated by the mounting surface when the transmitter is mounted to or removed from the mounting surface.

25. The method of claim 20 wherein the controller is programmed to activate the illumination activator in response to receiving an indication that the proximity of the at least a portion of the user is at a first distance from the at least one sensor and the controller is programmed to activate the transmitter code activator in response to receiving an indication that the proximity of the at least a portion of the user is at a second distance from the sensor, the first distance being greater than the second distance.

26. The method of claim 20 wherein the at least one sensor is selected from the group consisting of:
a capacitance sensor;
a radio frequency (RF) energy detector;
an infrared energy sensor; and
a visible light sensor.
